(19) United States
(12) Patent Application Publication
(10) Pub. No.: US 2016/0212796 A1
(43) Pub. Date: Jul. 21, 2016

(54) SYSTEM AND METHOD FOR PROJECTING A DISPLAYED IMAGE OF AN ELECTRONIC DEVICE THROUGH NETWORKING

(71) Applicant: AWIND Inc., New Taipei (TW)

(72) Inventors: HSING-YUNG WANG, New Taipei (TW); PO-TSUN CHOU, New Taipei (TW); MING-HUEI LIN, New Taipei (TW); SHENG-YI WANG, New Taipei (TW); LI-GER CHEN, New Taipei (TW)

(21) Appl. No.: 14/688,322

(22) Filed: Apr. 16, 2015

(30) Foreign Application Priority Data
Jan. 20, 2015 (TW) 104101730

(51) Int. Cl. H04W 84/12; H04N 9/31

(52) U.S. Cl. CPC H04W 84/12; H04N 9/31

(57) ABSTRACT

A system for projecting a displayed image of an electronic device through networking, applied to a conference room having at least one Wi-Fi AP, includes at least one electronic device, at least one USB flash drive and a receiving module. The electronic device further has a screen, a wireless network module and an identity. The USB flash drive is to store a pairing information and a network projection software. The receiving module further has an IP address. When the USB flash drive is connected with the electronic device, the electronic device captures the pairing information and uses the wireless network module to couple the at least one Wi-Fi AP, the electronic device further uses the pairing information to login the IP address of the receiving module, and then the electronic device uses the network projection software to output the displayed image to the receiving module.

This application claims the benefit of Taiwan Patent Application Serial No. 104101730, filed Jan. 20, 2015, the subject matter of which is incorporated herein by reference.

### BACKGROUND OF INVENTION

1. Field of the Invention

The invention relates to a system and a method for projecting a displayed image of an electronic device through networking, and more particularly to the system and the method for projecting a displayed image of an electronic device through networking that use a token to recognize the identity of the electronic device.

2. Description of the Prior Art

In company's internal meeting, either a coordinating meeting or a brainstorming meeting, the chair of the meeting is generally open to accept any opinion from each attendant verbally or well-prepared with computerized data. In most of the cases, people usually prepare their opinions, briefs, reports or proposals with computers, particularly the notebook computers. In a modern meeting or conference, it is normally that each attendant brings a notebook computer with him/her to the conference room, and, if required, the notebook computer can be cabled to a projector for displaying the data (briefing data for example) stored thereinside onto the screen of the conference room.

In the art, the connection between the computer and the conventional projector needs a transmission cable so as able thereby to transmit the displayed image of the computer to the projector. In a conference, if more than one attendant needs to demonstrate his/her computerized data on the main screen of the conference room through the projector, then it would be inevitable to apply more than one transmission cable or to frequently rearrange the same transmission cable among plural computers. Obviously, such a reconnection of the projector and the target computer would definitely delay the meeting. More worse, if the transmission cable is not long enough to reach each of the computer, the computer and the attendant having the computer would need to cumbersomely relocate their positions in the conference room.

Referring now to FIG. 1, a schematic view showing a conventional Wi-Fi wireless projector to display displayed images of respective computers is shown. In this conference room, a Wi-Fi wireless projector 10 and a plurality of computers 12 are provided, in which the Wi-Fi wireless projector 10 is connected with a network and thus is capable of wireless accessing through the network. The plurality of the computers 12 is brought to the conference room by specific attendants. Before the meeting, each of the aforesaid attendants needs to search the Wi-Fi AP (Access Point) of the Wi-Fi projector 10 firstly, and then input the password so as to establish a wireless network connection with the Wi-Fi projector 10. In addition, if the displayed image of the computer 12 is to be transmitted to the Wi-Fi projector 10 through networking, a specific network projection program (for example, a mirror output program) is required in advance to be installed into the computer 12, such that the displayed image of the computer 12 can be transmitted wireless to the Wi-Fi projector 10.

However, it is not always the case that every attendant of the meeting is familiar with the setting of wireless network. In addition, it is also not for every computer to install the necessary network projection program in advance. Further, the requirement of a password may avoid trivial persons or computers to connect the Wi-Fi projector. In some particular cases, some persons whose computers may have been setup with effective passwords in a previous meeting might not be among the attendant of this current meeting. However, if these persons as well as their computers are not admitted to this current meeting but strayed around the conference room in a communication distance, it is quite possible that these computers could be connected to the Wi-Fi projector automatically. More severely, the displayed images of these strayed computers outside the conference room may be accidentally outputted to the Wi-Fi wireless projector inside the conference room. Obviously, such a situation is not welcome for these strayed persons and their computers are nothing related to the discussion inside the conference room.

Therefore, it is definitely welcome to the art that an improvement aiming at the aforesaid wireless communication shortcomings can be proposed.

### SUMMARY OF THE INVENTION

Accordingly, it is the primary object of the present invention to provide a system for projecting a displayed image of an electronic device through networking, through which the instant displayed image of the electronic device can be smoothly outputted to a common receiving module so as to enhance the efficiency of the conference.

It is another object of the present invention to provide a method for projecting a displayed image of an electronic device through networking, by which the instant displayed image of the electronic device can be smoothly outputted to a common receiving module so as to enhance the efficiency of the conference.

In the present invention, the system for projecting a displayed image of an electronic device through networking is installed inside a conference room that provides a plurality of Wi-Fi APs for wireless network connecting respective electronic devices with individual identities.

The system of the present invention includes at least one electronic device, at least one USB flash drive and a receiving module. The electronic device has a screen, a wireless network module and an identity. The USB flash drive has an internal token, a pairing information and a network projection software. The pairing information includes an IP address of the receiving module, a login password and setup data for the plurality of Wi-Fi APs. When the receiving module connects with a network, the IP address of the receiving module can be accessed through the token and the login password.

The method of the present invention includes: a step of a USB flash drive having a token and a pairing information being connected with an electronic device; a step of the electronic device running a network projection software stored in the USB flash drive; a step of the electronic device capturing the token data and the pairing information from the USB flash drive; a step of determining if the electronic device is connected with a network or not; a step of the electronic device using the token and the pairing information to login an IP address of a receiving module if positive and the electronic device performing the following step if negative; a step of a Wi-Fi AP respective to an identity being selected to establish a wireless network connection, and the token and the pairing information being further used to login the IP address of the receiving module as the identity of the electronic device being recognized; and, a step of the electronic device outputting a displayed image thereof to the receiving module.

In the present invention, the electronic device can be a notebook computer having the USB connector, and the receiving module can be a processing device with a Wi-Fi function connecting to a monitor via an HDMI connector or a VGA connector, or a monitor with a Wi-Fi function such as a Wi-Fi projector, a Wi-Fi television and any the like. In addition, the USB flash drive can include an autorun. When the USB flash drive is connected with the electronic device, the electronic device would run the application program automatically so as to output the displayed image of the electronic device to the receiving module.

All these objects are achieved by the system and the method for projecting a displayed image of an electronic device through networking described below.

### BRIEF DESCRIPTION OF THE DRAWINGS

The present invention will now be specified with reference to its preferred embodiment illustrated in the drawings, in which:

FIG. 1 is a schematic view showing a conventional Wi-Fi wireless projector to display displayed images of respective computers;

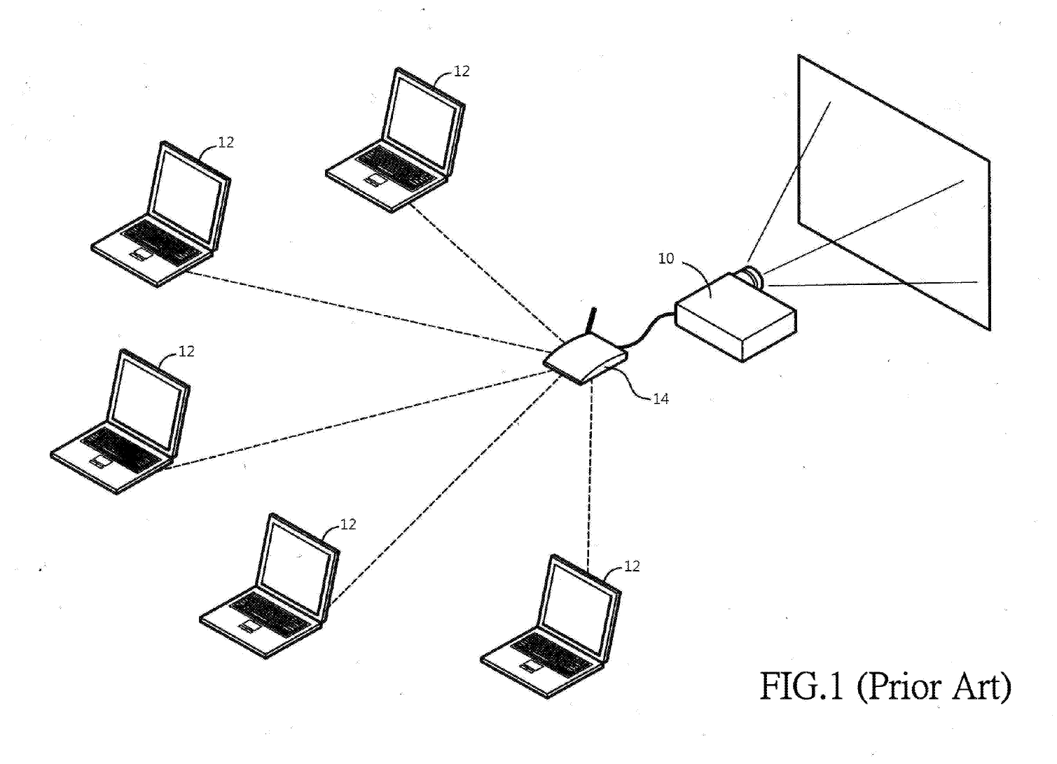

FIG. 2 is a block view of the preferred system for projecting a displayed image of an electronic device through networking in accordance with the present invention;

FIG. 3 is a flowchart of a first embodiment of the method for projecting a displayed image of an electronic device through networking in accordance with the present invention; and

FIG. 4 is a flowchart of a second embodiment of the method for projecting a displayed image of an electronic device through networking in accordance with the present invention.

### DESCRIPTION OF THE PREFERRED EMBODIMENT

The invention disclosed herein is directed to a system and a method for projecting a displayed image of an electronic device through networking. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

Generally, a plurality of conference rooms is usually contemporarily existed in a company. In addition, each conference room would be provided with a plurality of Wi-Fi APs for various computers possible brought into the conference room for individual purposes. Further, it is also possible that different computer identities would be assigned to different computers, such as an employee computer or a client computer. In the present invention, the system and the method for projecting a displayed image of an electronic device through networking can be applied to the situation described above and can meet the requirements generally configured for the conference room of the company to enhance the efficiency of the internal meetings of the company. Details about the present invention are disclosed hereinafter by accompanying exemplary embodiments.

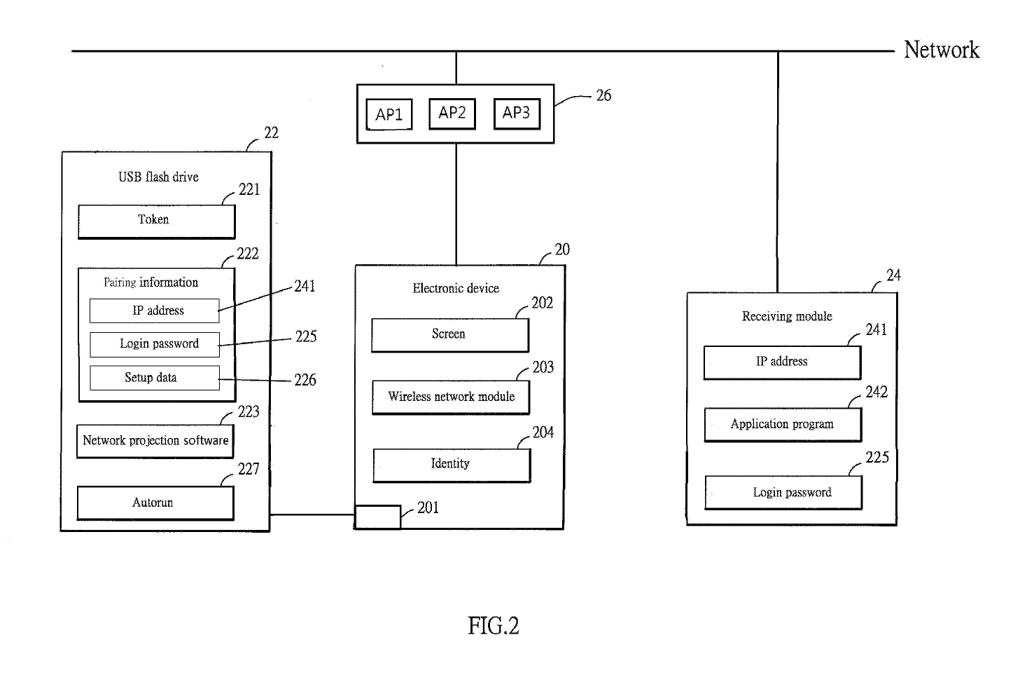

Referring now to FIG. 2, a block view of the preferred system for projecting a displayed image of an electronic device through networking in accordance with the present invention is schematically shown. The system is constructed into a conference room with facilities as described above. The conference room includes a plurality of electronic devices 20, at least one USB flash drive 22 and a receiving module 24. In the following explanation of the system, a unique electronic device 20 is typically used in order to concisely elucidate the system and the method of the present invention.

In the present invention, the electronic device 20 can be a notebook computer or any device that is able to process like a computer. The electronic device 20 has a USB connector 201, a screen 202, a wireless network module 203 and an identity 204. The identity 204 can be a name of the electronic device 20, which the name is usually assigned by the MIS personnel of the company at the very first day in the company. For example, a name of ABC01 might stand for the number 1 electronic device 20 for the ABC company.

The USB flash drive 22 as a storage device has an internal token 221, a pairing information 222 and a network projection software 223. Generally speaking, the token 221 is usually the original setting of the manufacturer of the USB flash drive 22, i.e. the authentication code or the vendor ID that can only be written once and ever for the product and can't be read by other companies or users. Hence, even that data stored in the USB flash drive is duplicated, the internal unchangeable token is still not to be copied or read. On the other hand, the pairing information 222 is changeable that can be altered by the manufacturer, the MIS personnel of a company, or the user. When the USB flash drive 22 is connected with the USB connector 201 of the electronic device 20, the electronic device 20 would capture the token 221 and the pairing information 222 from the USB flash drive 22, in which the token 221 is mainly to recognize the identity of the USB flash drive 20 upon if the connected USB flash drive 20 is an authentic product, not a duplicate. As the identity is confirmed, the user of the USB flash drive 22 is admitted as a qualified attendant of the specific meeting. As the USB flash drive 22 is connected with an electronic device 20, the user of the electronic device 20 is then automatically authorized to be a qualified participant of the specific meeting. In the present invention, the pairing information 222 includes an IP address 241 of the receiving module 24, a login password 225 and setup data 226 for a plurality of Wi-Fi APs, in which these Wi-Fi APs 26 are generally network resources provided by the company and the setup data 226 is usually stored in USB flash drive 22 by the MIS personnel of the company. If the electronic device 20 is yet to connect the internal wireless network of the company after the meeting is initiated, the user can use the setup data 226 to configure the wireless network and thereby to establish network connection with one of the Wi-Fi APs 26.

The receiving module 24 can be a processing device with a Wi-Fi function connecting to a monitor via a HDMI connector or a VGA connector, or a monitor with a Wi-Fi function such as a Wi-Fi projector or a Wi-Fi television. Moreover, the receiving module 23 has the IP address 241. When the receiving module 24 connects with a network, the IP address 241 of the receiving module 24 can be accessed through the token 221 and the login password 225. In addition, the receiving module 24 further includes an application program 242 for recognizing the token 221 and the login password 225 of the electronic device 20.

In one embodiment of the present invention, the receiving module 24 can be configured as a device needing no login password. In such an application, the network connection between the electronic device 20 and the receiving module 24 can be established only if the IP address 241 is confirmed. Namely, in this embodiment, the pairing information 222 of the USB flash drive 22 includes simply the IP address 241 of the receiving module 24 and the setup data 226 for the Wi-Fi APs. Further, in another embodiment of the present invention, the login password 225 can be stored in the receiving module 24 and directly displayed on a screen of the receiving module 24 for the user to read and then apply the login password 225 to establish the wireless network connection between the electronic device 20 and the receiving module 24. In addition, the login password 225 of the present invention can be a rolling password, which is varied on the screen of the receiving module 24 in a specific time period. Upon such an arrangement, while a qualified user joins the meeting in a later time, he/she can directly connect his/her computer by applying the login password 225 already displayed on the screen of the electronic device 20. Herein, the pairing information 222 of the USB flash drive 22 needs only the IP address 241 of the receiving module 24 and the setup data 226 for the Wi-Fi APs.

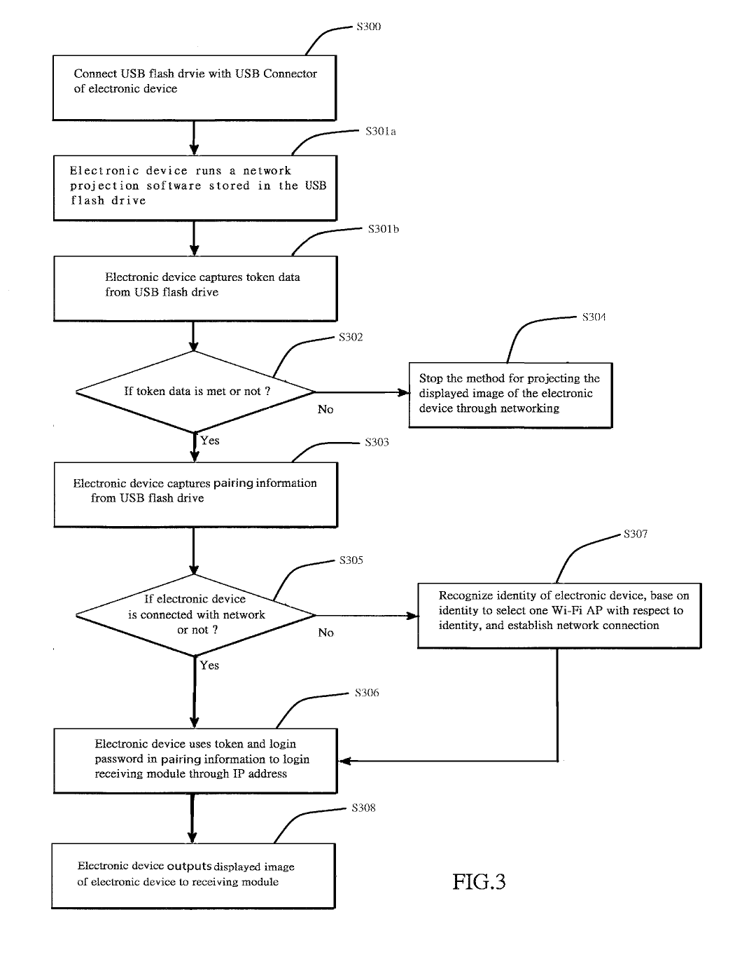

Referring now to FIG. 3, a flowchart of a first embodiment of the method for projecting a displayed image of an electronic device through networking in accordance with the present invention is shown. In this embodiment, the method for projecting a displayed image of an electronic device through networking includes the following steps. Firstly, the USB flash drive is connected with a USB connector of the electronic device (S300). Secondly, the electronic device runs a network projection software stored in the USB flash drive (S301a). Then, the electronic device captures the token data from the USB flash drive (S301b), and judges if the token data is met or not (S302). If the judgment is positive, then the electronic device would capture the pairing information from the USB flash drive (S303). Otherwise (i.e. if negative), stop the method for projecting the displayed image of the electronic device through networking (S304). After the positive judgment, a determination of whether or not the electronic device is connected with a network is processed (S305). If the network connection is established, the electronic device would use the token and the login password in the pairing information to login the receiving module through the IP address (S306). If negative, then recognize the identity of the electronic device, base on the identity to select one of the Wi-Fi APs in the conference room with respect to the identity, and establish the network connection between the electronic device and the receiving module (S307). Further, after the Step S307, the Step S306 is performed again. Finally, the electronic device outputs the displayed image of the electronic device to the receiving module (S308).

Generally, in Step S301a, the network projection software can be manually executed by a user or automatically executed by an autorun stored 227 in the USB flash drive 22 (shown in FIG. 2). In addition, a company's internal meeting contains mainly the employees of the company with few external inviters, for example, from the related clients. Most of the time, the electronic devices of the respective employees are usually turned on and connected already with the network as long as the employees are in the office. On the other hand, to the clients, except for some advanced arrangements, the clients' electronic devices would not be able to connect with the company's network. Hence, in Step S305, the judgment of whether or not the individual electronic device is connected with the network is performed firstly. On the other hand, if the receiving module of the present invention does not need a login password, then, in the aforesaid Step S306, the electronic device can simply use the token and the IP address in the pairing information to establish the network connection with the receiving module. In addition, if the login password for the receiving module is posted on the screen of the receiving module, then, in Step S306, the electronic device would use the token and also input the login password posted on the screen of the receiving module so as to establish the network connection with the receiving module. In the present invention, the login password shown on the screen of the receiving module can be a rolling password, which is varied on the screen in a specific time period. Upon such an arrangement, as long as any one participates the meeting midway in the discussion, his/her electronic device shall copy the instant login password shown on the screen, so that the network connection between the electronic device and the receiving module can thus be established.

To avoid possible network jam and consider the network safety, the company usually provides only a limited number of the Wi-Fi APs for the meeting that might include both the internal employees and the external participants. Thus, in the foregoing Step S307, the identity of the electronic device is recognized firstly, then, based on the setup data for the plurality of the Wi-Fi APs provided by the USB flash drive, a specific Wi-Fi AP with respect to the identity would be chosen to establish the network connection.

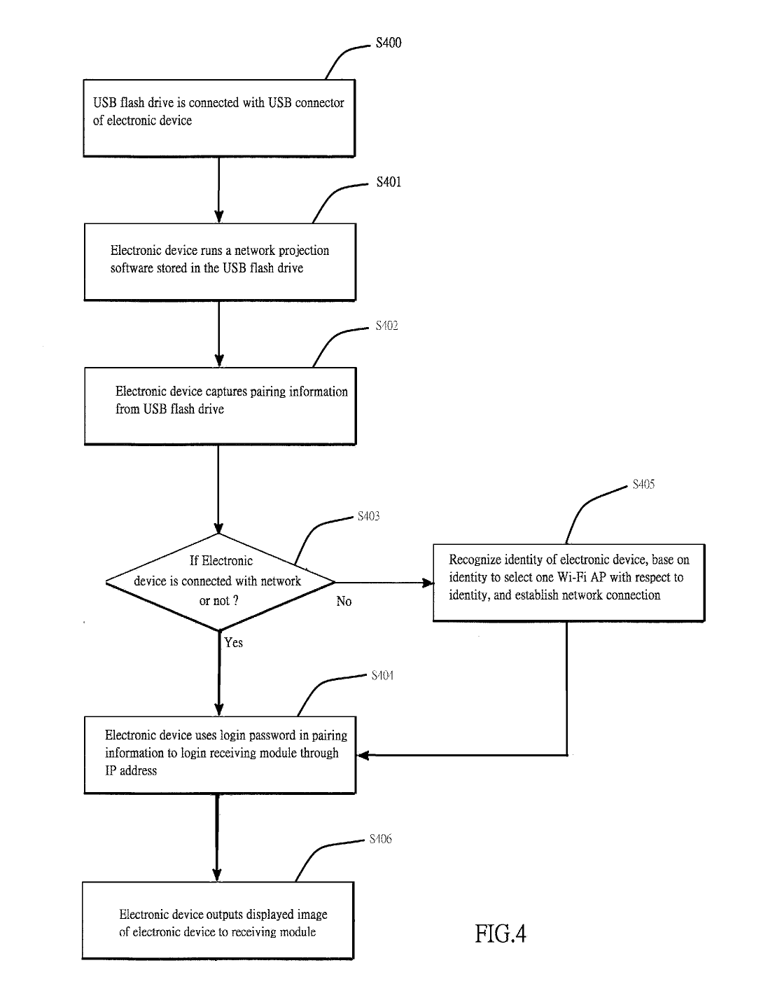

Referring now to FIG. 4, a flowchart of a second embodiment of the method for projecting a displayed image of an electronic device through networking in accordance with the present invention is shown. In this embodiment, the method for projecting a displayed image of an electronic device through networking includes the following steps. Firstly, the USB flash drive is connected with a USB connector of the electronic device (S400). Secondly, the electronic device runs a network projection software stored in the USB flash drive (S401). Then, the electronic device captures the pairing information from the USB flash drive (S402). Next, judge whether or not the electronic device is connected with a network is processed (S403). If the network connection is established, the electronic device would use the login password in the pairing information to login the receiving module through the IP address (S404). If negative, then recognize the identity of the electronic device, base on the identity to select one of the Wi-Fi APs in the conference room with respect to the identity, and establish the network connection between the electronic device and the receiving module (S405). Further, after the Step S405, the Step S404 is performed again. Finally, the electronic device outputs the displayed image of the electronic device to the receiving module (S406).

As described above, in Step S401, the network projection software can be manually executed by a user or automatically executed by the autorun stored 227 in the USB flash drive 22 (shown in FIG. 2). In addition, the Step S403 is mainly to judge whether or not the individual electronic device of the attendant is connected with the network. On the other hand, if the receiving module of the present invention does not need a login password, then, in the aforesaid Step S404, the electronic device can simply use the IP address in the pairing information to establish the network connection with the receiving module. In addition, if the login password for the receiving module is posted on the screen of the receiving module, then, in Step S404, the electronic device shall input the login password posted on the screen of the receiving module so as to establish the network connection with the receiving module. In the present invention, the login password shown on the screen of the receiving module can be a rolling password, which is varied on the screen in a specific time period. Upon such an arrangement, as long as any one participates the meeting midway in the discussion, his/her electronic device shall copy the instant login password shown on the screen, so that the network connection between the electronic device and the receiving module can thus be established.

On the other hand, the network projection software stored inside the USB flash drive can be a software program to be executed by the electronic device. Thus, the participants of the meeting need not to install the network projection software into their own electronic devices in advance. As long as the participant enters the conference room, the USB flash drive already prepared in the conference room can be provided to connect with his/her personal electronic device, such that related setup can be performed in the electronic device by the plugged USB flash drive to prepare the electronic device ready for outputting the displayed image to be projected onto the conference screen.

Generally, a conference room has a single receiving module (a projector for example), but can contain many participants or attendants, among which some of those participants would bring the personal electronic devices to attain the meeting. Therefore, the method and the system of the present invention can include a plurality of USB flash drives (say, 10-20) in the conference room. These USB flash drives are all prepared to include the same tokens, the same pairing information and the same network projection software, in which the token can only be recognized by the application program of the receiving module in the conference room. Upon such an arrangement, as a participant enters the conference room, he/she needs to pick one of the USB flash drives prepared in the conference room to connect with his/her own electronic device, and then he/she and his/her electronic device are then well prepared to participate the meeting and to show his/her data stored in his/her electronic device public to the conference screen. By compared to the art, no more tedious installation and setup is needed while applying the method and the system of the present invention disclosed above.

As stated above, in the conference room, a plurality of the USB flash drive are prepared to each of participants' electronic devices. Thus, difficulty for preparing a meeting with various electronic devices inside to demonstrate versatile data can be greatly reduced. In the case if any USB flash drive is carelessly carried out of the conference room, the MIS personnel of the company should alter directly the login password of the receiving module in the conference room and the login password in the pairing information of the USB flash drive prepared for the conference room, and then a later meeting would be prevented from an accidental demonstration of irrelevant displayed image of the electronic device with the strayed USB flash drive.

While the present invention has been particularly shown and described with reference to a preferred embodiment, it will be understood by those skilled in the art that various changes in form and detail may be without departing from the spirit and scope of the present invention.

What is claimed is:

1. A system for projecting a displayed image of an electronic device through networking, applied to a conference room having at least one Wi-Fi AP, comprising:
at least one electronic device, having a screen, a wireless network module and an identity;
at least one USB flash drive, storing a pairing information and a network projection software; and
a receiving module, having an IP address;
wherein, when the USB flash drive is connected with the electronic device, the electronic device captures the pairing information and uses the wireless network module to couple the at least one Wi-Fi AP, the electronic device further uses the pairing information to login the IP address of the receiving module, and then the electronic device uses the network projection software to output the displayed image to the receiving module.

2. The system for projecting a displayed image of an electronic device through networking of claim 1, wherein the USB flash drive further stores a token, and wherein, when the USB flash drive is connected with the electronic device, the electronic device captures the token from the USB flash drive, then connects the at least one Wi-Fi AP through the wireless network module, then further uses the token to login the IP address of the receiving module, and finally runs the network projection software so as to output the displayed image to the receiving module.

3. The system for projecting a displayed image of an electronic device through networking of claim 2, wherein the receiving module is a monitor with a Wi-Fi function.

4. The system for projecting a displayed image of an electronic device through networking of claim 3, wherein the monitor is one of a Wi-Fi wireless projector and a Wi-Fi television.

5. The system for projecting a displayed image of an electronic device through networking of claim 2, wherein the pairing information includes the IP address of the receiving module and a login password, the electronic device uses the token and the login password to login the IP address of the receiving module, and the electronic device outputs the displayed image to the receiving module.

6. The system for projecting a displayed image of an electronic device through networking of claim 5, wherein the receiving module further includes an application program for recognizing the token and the login password of the electronic device.

7. The system for projecting a displayed image of an electronic device through networking of claim 2, wherein the conference room provides a plurality of Wi-Fi APs, the pairing information includes setup data of the plurality of Wi-Fi APs, the wireless network module of the electronic device bases on the identity of the electronic device to select the Wi-Fi AP respective to the identity from the setup data to establish a wireless network connection in between.

8. The system for projecting a displayed image of an electronic device through networking of claim 2, wherein the electronic device is a computer having the USB connector.

9. The system for projecting a displayed image of an electronic device through networking of claim 2, wherein the USB flash drive further includes an autorun, and wherein, when the USB flash drive is connected with the electronic device, the electronic device runs the autorun automatically so as to output the displayed image to the receiving module.

10. The system for projecting a displayed image of an electronic device through networking of claim 2, wherein the receiving module is a processing device with a Wi-Fi function connecting to a monitor via one of an HDMI connector and a VGA connector.

11. A method for projecting a displayed image of an electronic device through networking, comprising the steps of:
(a) a USB flash drive having a token and a pairing information being connected with an electronic device;
(b) the electronic device running a network projection software stored in the USB flash drive;
(c) the electronic device capturing the token data from the USB flash drive;
(d) the electronic device judging if the token data is met or not;
(e) if positive, the electronic device capturing the pairing information from the USB flash drive; and, if negative, stopping the method;
(f) determining if the electronic device is connected with a network or not;
(g) if positive, the electronic device using the token and the pairing information to login an IP address of a receiving module; and, if negative, the electronic device performing the following step;
(h) as an identity of the electronic device being recognized, a Wi-Fi AP respective to the identity being selected to establish a wireless network connection, and the token and the pairing information being further used to login the IP address of the receiving module; and
(i) the electronic device outputting a displayed image thereof to the receiving module.

12. The method for projecting a displayed image of an electronic device through networking of claim 11, wherein the pairing information includes the IP address of the receiving module, and the electronic device uses the IP address and the receiving module to establish the network connection for outputting the displayed image of the electronic device to the receiving module.

13. The method for projecting a displayed image of an electronic device through networking of claim 11, wherein the pairing information includes the IP address of the receiving module and a login password, and the electronic device uses the login password to login the IP address of the receiving module so as to establish the network connection with the receiving module and further to output the displayed image of the electronic device to the receiving module.

14. The method for projecting a displayed image of an electronic device through networking of claim 11, wherein the pairing information further includes a plurality of setup data of the Wi-Fi AP, and the Wi-Fi AP only allows, by judging the setup data, the electronic device with the specific identity to establish the wireless network connection in between.

15. The method for projecting a displayed image of an electronic device through networking of claim 11, wherein the USB flash drive further includes an autorun, and, when the USB flash drive is connected with the electronic device, the autorun is to control the electronic device to run the network projection software automatically.

16. The method for projecting a displayed image of an electronic device through networking of claim 11, wherein the pairing information includes the IP address of the receiving module, the receiving module has a screen for displaying a login password, the electronic device uses the login password shown in the screen to login the IP address of the receiving module and further to output the displayed image of the electronic device to the receiving module.

17. The method for projecting a displayed image of an electronic device through networking of claim 16, wherein the login password shown on the screen of the receiving module is a rolling password, which is varied on the screen in a specific time period.

18. A method for projecting a displayed image of an electronic device through networking, comprising the steps of:
(a) a USB flash drive having a pairing information being connected with an electronic device;
(b) the electronic device running a network projection software stored in the USB flash drive;
(c) the electronic device capturing the pairing information from the USB flash drive;
(d) judging if the electronic device is connected with a network or not;
(e) if positive, the electronic device using the pairing information to login an IP address of a receiving module; and, if negative, performing the following step;
(f) as an identity of the electronic device being recognized, a Wi-Fi AP respective to the identity being selected to establish a wireless network connection, and the pairing information being further used to login the IP address of the receiving module; and
(g) the electronic device outputting a displayed image thereof to the receiving module.

19. The method for projecting a displayed image of an electronic device through networking of claim 18, wherein the pairing information includes the IP address of the receiving module, and the electronic device uses the IP address and the receiving module to establish the network connection for outputting the displayed image of the electronic device to the receiving module.

20. The method for projecting a displayed image of an electronic device through networking of claim 18, wherein the pairing information includes the IP address of the receiving module and a login password, and the electronic device uses the login password to login the IP address of the receiving module so as to establish the network connection with the receiving module and further to output the displayed image of the electronic device to the receiving module.

21. The method for projecting a displayed image of an electronic device through networking of claim 18, wherein the pairing information further includes a plurality of setup data of the Wi-Fi AP, and the Wi-Fi AP only allows, by judging the setup data, the electronic device with the specific identity to establish the wireless network connection in between.

22. The method for projecting a displayed image of an electronic device through networking of claim 18, wherein the USB flash drive further includes an autorun, and, when the USB flash drive is connected with the electronic device, the autorun is to control the electronic device to run the network projection software automatically.

23. The method for projecting a displayed image of an electronic device through networking of claim 18, wherein the pairing information includes the IP address of the receiving module, the receiving module has a screen for displaying a login password, the electronic device uses the login password shown in the screen to login the IP address of the receiving module and further to output the displayed image of the electronic device to the receiving module.

24. The method for projecting a displayed image of an electronic device through networking of claim 23, wherein the login password shown on the screen of the receiving module is a rolling password, which is varied on the screen in a specific time period.
